(19) United States
(12) Patent Application Publication
(10) Pub. No.: US 2026/0311349 A1
(43) Pub. Date: Oct. 8, 2026

(54) METHODS AND APPARATUS FOR DEEP LEARNING BASED INTER-MODAL IMAGE REGISTRATION AND RECONSTRUCTION

(71) Applicant: Siemens Medical Solutions USA, Inc., Malvern, PA (US)

(72) Inventors: Joshua Schaefferkoetter, Knoxville, TN (US); Jorge Cabello, Lenoir City, TN (US)

(21) Appl. No.: 19/169,411

(22) Filed: Apr. 3, 2025

(51) Int. Cl. G06T 7/30; G06T 3/14; G06T 11/00

(52) U.S. Cl. CPC G06T 7/30; G06T 3/14; G06T 12/10; G06T 12/20; G06T 2207/10081; G06T 2207/10088; G06T 2207/10104; G06T 2207/20081; G06T 2207/20084; G06T 2207/30004; G06T 2210/41; G06T 2211/441

(57) ABSTRACT

Systems and methods for deep-learning based inter-modal registration processes and image reconstruction are disclosed. For example, an image reconstruction system receives a positron emission tomography (PET) image and a co-modality image from an image scanning system. The system applies a trained machine learning process to the PET image and the co-modality image to generate transformation data characterizing an alignment between the PET image and the co-modality image, and generates a transformed image by transforming the co-modality image based on the transformation data. If the transformed image is not sufficiently aligned with the PET image, the system applies the trained machine learning process to the PET image and the transformed image to generate additional transformation data characterizing an alignment between the PET image and the transformed image. This iterative process continues until the transformed image is registered to the PET image.

### FIELD

Aspects of the present disclosure relate in general to medical diagnostic systems and, more particularly, to reconstructing images from nuclear imaging systems for diagnostic and reporting purposes.

### BACKGROUND

Nuclear imaging systems can employ various technologies to capture images. For example, some nuclear imaging systems employ positron emission tomography (PET) to capture images. PET is a nuclear medicine imaging technique that produces tomographic images representing the distribution of positron emitting isotopes within a body. Some nuclear imaging systems employ computed tomography (CT), for example, as a co-modality. CT is an imaging technique that uses x-rays to produce anatomical images. Magnetic Resonance Imaging (MRI) is an imaging technique that uses magnetic fields and radio waves to generate anatomical and functional images, and can also be used as a co-modality. Typically, these nuclear imaging systems capture measurement data, and process the captured measurement data using mathematical algorithms to reconstruct medical images.

Some nuclear imaging systems combine PET and co-modality images for various imaging applications. For example, nuclear imaging systems may combine PET and co-modality images to display information from both of the images. In some instances, co-modality data is used to correct PET images, such as for attenuation. For example, in PET/CT systems, CT measurement information can be used to generate an attenuation map, where the attenuation map is used to correct PET measurement data for attenuation (i.e., attenuation correction of a PET image). Similarly, some nuclear imaging systems can use measurement information from an MRI scan to correct a PET image. Typically, these nuclear imaging systems perform conventional registration techniques in an attempt to align the co-modality image with the PET image to perform these various imaging applications.

These conventional systems, however, can suffer from drawbacks. For instance, conventional registration methods can suffer from inaccuracies, thereby causing further inaccuracies in reconstructed images. Moreover, subjects may move during and/or between PET and co-modality scans, thereby causing the PET and co-modality images to be captured of the patient in different positions. As a result, the images may be misaligned when, for instance, they are displayed together (e.g., misaligned when one is superimposed over the other). Further, the misalignment can lead to inaccurate attenuation correction, for instance, when using the co-modality measurement data to correct the PET measurement data for attenuation. Moreover, current motion correction and registration techniques can be time-intensive and cause inaccurate and lower quality medical images. As such, there are opportunities to address deficiencies in nuclear imaging systems.

### SUMMARY

Systems and methods for deep-learning based inter-modal registration processes and image reconstruction are disclosed.

In some embodiments, a computer-implemented method includes receiving a positron emission tomography (PET) image (e.g., TOF sinogram data, list mode data) and a co-modality image (e.g., μu-map, MR image). Further, the method includes applying a trained machine learning process to the PET image and the co-modality image and, based on the application of the trained machine learning process to the PET image and the co-modality image, generating first transformation data characterizing an alignment between the PET image and the co-modality image. The method also includes generating a first transformed image based on the co-modality image and the first transformation data. Further, the method includes determining that the first transformed image is not registered with the PET image based on the first transformation data. The method also includes applying the trained machine learning process to the PET image and the first transformed image and, based on the application of the trained machine learning process to the PET image and the first transformed image, generating second transformation data characterizing an alignment between the PET image and the first transformed image. The method further includes generating a second transformed image based on the first transformed image and the second transformation data. The method also includes storing the second transformed image in a data repository.

In some embodiments, a non-transitory computer readable medium stores instructions that, when executed by at least one processor, cause the at least one processor to perform operations. The operations include receiving a positron emission tomography (PET) image and a co-modality image. Further, the operations include applying a trained machine learning process to the PET image and the co-modality image and, based on the application of the trained machine learning process to the PET image and the co-modality image, generating first transformation data characterizing an alignment between the PET image and the co-modality image. The operations also include generating a first transformed image based on the co-modality image and the first transformation data. Further, the operations include determining that the first transformed image is not registered with the PET image based on the first transformation data. The operations also include applying the trained machine learning process to the PET image and the first transformed image and, based on the application of the trained machine learning process to the PET image and the first transformed image, generating second transformation data characterizing an alignment between the PET image and the first transformed image. The operations further include generating a second transformed image based on the first transformed image and the second transformation data. The operations also include storing the second transformed image in a data repository.

In some embodiments, an apparatus includes a memory storing instructions, and at least one processor communicatively coupled the memory. The at least one processor is configured to execute the instructions to perform operations. The operations include receiving a positron emission tomography (PET) image and a co-modality image. Further, the operations include applying a trained machine learning process to the PET image and the co-modality image and, based on the application of the trained machine learning process to the PET image and the co-modality image, generating first transformation data characterizing an alignment between the PET image and the co-modality image. The operations also include generating a first transformed image based on the co-modality image and the first transformation data. Further, the operations include determining that the first transformed image is not registered with the PET image based on the first transformation data. The operations also include applying the trained machine learning process to the PET image and the first transformed image and, based on the application of the trained machine learning process to the PET image and the first transformed image, generating second transformation data characterizing an alignment between the PET image and the first transformed image. The operations further include generating a second transformed image based on the first transformed image and the second transformation data. The operations also include storing the second transformed image in a data repository.

In some embodiments, a computer-implemented method includes receiving PET images and corresponding co-modality images. The method also includes inputting the PET images and the co-modality images into a machine learning process and, based on inputting the PET images and the co-modality images, generating transformation data. Further, the method includes adjusting parameters of the machine learning process based on the transformation data, where the parameter adjustments correct for misalignments between the PET images and the co-modality images. The method also includes generating a loss value based on the transformation data and ground truth data. The method further includes determining the machine learning process is trained based on the loss value and a threshold value. The operations also include storing the parameters of the trained machine learning process in a data repository.

In some embodiments, a non-transitory computer readable medium stores instructions that, when executed by at least one processor, cause the at least one processor to perform operations. The operations include receiving PET images and corresponding co-modality images. The operations also include inputting the PET images and the co-modality images into a machine learning process and, based on inputting the PET images and the co-modality images, generating transformation data. Further, the operations include adjusting parameters of the machine learning process based on the transformation data, where the parameter adjustments correct for misalignments between the PET images and the co-modality images. The operations also include generating a loss value based on the transformation data and ground truth data. The operations further include determining the machine learning process is trained based on the loss value and a threshold value. The operations also include storing the parameters of the trained machine learning process in a data repository.

In some embodiments, an apparatus includes a memory storing instructions, and at least one processor communicatively coupled the memory. The at least one processor is configured to execute the instructions to perform operations. The operations include receiving PET images and corresponding co-modality images. The operations also include inputting the PET images and the co-modality images into a machine learning process and, based on inputting the PET images and the co-modality images, generating transformation data. Further, the operations include adjusting parameters of the machine learning process based on the transformation data, where the parameter adjustments correct for misalignments between the PET images and the co-modality images. The operations also include generating a loss value based on the transformation data and ground truth data. The operations further include determining the machine learning process is trained based on the loss value and a threshold value. The operations also include storing the parameters of the trained machine learning process in a data repository.

### BRIEF DESCRIPTION OF THE DRAWINGS

The following will be apparent from elements of the figures, which are provided for illustrative purposes and are not necessarily drawn to scale.

FIG. 1 illustrates a nuclear image reconstruction system, in accordance with some embodiments.

FIG. 2 illustrates a block diagram of an example computing device that can perform one or more of the functions described herein, in accordance with some embodiments.

FIG. 3 illustrates a neural network of a nuclear imaging system, in accordance with some embodiments.

FIG. 4 illustrates a machine learning model training system, in accordance with some embodiments.

FIG. 5 is a flowchart of an example method to register images, in accordance with some embodiments.

FIG. 6 is a flowchart of an example method to train a machine learning model, in accordance with some embodiments.

FIGS. 7A, 7B, 7C, 8A, 8B, 8C, 8D illustrate images before and after registration, in accordance with some embodiments.

FIG. 9 illustrates a nuclear image reconstruction system, in accordance with some embodiments.

### DETAILED DESCRIPTION

This description of the exemplary embodiments is intended to be read in connection with the accompanying drawings, which are to be considered part of the entire written description. Independent of the grammatical term usage, individuals with male, female, or other gender identities are included within the term.

The exemplary embodiments are described with respect to the claimed systems as well as with respect to the claimed methods. Furthermore, the exemplary embodiments are described with respect to methods and systems for image reconstruction, as well as with respect to methods and systems for training functions used for image reconstruction. Features, advantages, or alternative embodiments herein can be assigned to the other claimed objects and vice versa. For example, claims for the providing systems can be improved with features described or claimed in the context of the methods, and vice versa. In addition, the functional features of described or claimed methods are embodied by objective units of a providing system. Similarly, claims for methods and systems for training image reconstruction functions can be improved with features described or claimed in context of the methods and systems for image reconstruction, and vice versa.

Various embodiments of the present disclosure can employ machine learning methods or processes to provide clinical information from nuclear imaging systems. For example, the embodiments can employ machine learning methods or processes to reconstruct images based on captured measurement data, and provide the reconstructed images for clinical diagnosis. In some embodiments, machine learning methods or processes are trained, to improve the reconstruction of images.

Rigid alignment between images of different modalities is critical in various imaging applications. For instance, various positron emission tomography (PET) reconstruction processes make use of anatomical information from a co-modality image to reconstruct a PET image. As an example, quantitative PET or single-photon emission computed tomography (SPECT) generally requires an attenuation map (e.g., mu-map) to correct for a number of photons that have either been lost for a sinogram bin (i.e., attenuation correction) or wrongly assigned to another sinogram bin (i.e., scatter correction). The attenuation map characterizing the corrections (e.g., μ-map) can be calculated or estimated using an accompanying anatomical modality, such as computed tomography (CT) or magnetic resonance (MR) image.

Conventional approaches, however, can demonstrate inaccuracies. For instance, subjects may move during image capturing, which can cause misalignment issues during PET reconstruction. Motion of the subject during or between consecutive scans can result in an attenuation map (e.g., μ-map) that is spatially mismatched from the captured PET measurement data. As a result, when used for attenuation correction, the misaligned attenuation map can introduce quantitative artifacts in reconstructed PET images. For instance, subjects may breathe or voluntarily move portions of their body between consecutive scans. The movement may result in improper image alignment and thus improper attenuation correction of the PET measurement data. The misalignment and improper attenuation correction may cause inaccuracies in the reconstructed images that may be displayed to medical professionals for diagnostic purposes. Moreover, some applications can benefit from greater registration accuracies than provided by conventional registration processes.

In some embodiments, a machine learning model, such as a neural network (e.g., convolutional neural network (CNN)), is trained using PET images and corresponding co-modality images (e.g., CT images, μ-maps, MRI images) to generate transformation data characterizing alignments (e.g., misalignments) between the corresponding images. The transformation data can define transformations, such as offsets and rotations, between a PET image and co-modality image. During training, pairs of PET images and co-modality images, and ground truth data characterizing a misalignment between the pairs of PET images and co-modality images, is inputted into the machine learning model. In some examples, to generate the of PET images and co-modality images, otherwise aligned PET images and co-modality images are purposely adjusted to be misaligned, and ground truth data is generated characterizing the misalignment. The training may adjust parameters (e.g., weights) of the machine learning model such that the trained machine learning model is configured to generate the transformation data.

During training, the machine learning model may further output a transformed co-modality image. For instance, the machine learning model may adjust the co-modality image based on the transformation data to generate the transformed co-modality image to generate the transformed co-modality image. In other words, the transformed co-modality image is the inputted co-modality image transformed (e.g., offset, rotated) in accordance with the transformation data. In some examples, the trained machine learning model may adjust a three-dimensional position of each co-modality pixel position to align to a corresponding pixel location in the PET image based on the transformation data. Further, in some examples, and as described further herein, the transformed co-modality image is input back into the machine learning model being trained along with the same PET image to generate an additional transformed co-modality image. In other words, the estimated registration of a current iteration (e.g., the transformed co-modality image) is used as an input for the next iteration of training. This training process may repeat for a number of iterations.

Once trained, the machine learning model is configured to receive a PET image (or in some examples a SPECT image) and a co-modality image (e.g., MR image, attenuation map, etc.), and to generate transformation data characterizing an alignment (e.g., misalignment) between the PET image and the co-modality image. As described herein, the transformation data can define a transformation of the co-modality image to align to the PET image. For example, the transformation data can define a linear offset of the co-modality image from the PET image in one or more of three directions (e.g., x, y, z offsets in the x, y, z coordinate system, or offsets in the transaxial, sagittal, and coronal directions). Additionally or alternatively, the transformation data can define a rotation offset of the co-modality image from the PET image around one or more of the three directions (e.g., α, β, γ rotations around a corresponding axis). The trained machine learning model can transform (e.g., orient) the co-modality image based on the transformation data, and output the transformed image.

As described herein, based on the transformation data, the transformed co-modality image may be input back into the trained machine learning model and, in response, the trained machine learning model generates additional transformation data. The additional transformation data characterizes an alignment between the PET image and the initially transformed co-modality image. The machine learning model also outputs an additional transformed co-modality image, which is the initially transformed co-modality image transformed by the additional transformation data. These “feedback” operations (e.g., feeding the transformed co-modality image back into the trained machine learning model) may continue until the latest transformation data satisfies one or more conditions. For example, the operations may repeat until the latest transformation data satisfies one or more thresholds, as discussed further herein. When the transformation data satisfies the one or more conditions, the PET image can be reconstructed based on the last generated transformed co-modality image. For instance, the PET image can be reconstructed based on applying a trained machine learning process or artificial process (e.g., Fast PET) to the PET image and the most recently generated transformed co-modality image.

Among other advantages, the embodiments can allow for rigid inter-modal registration that is fast and accurate. For example, the embodiments can allow for more accurate image alignment from varying modalities (e.g., PET and CT, PET and MRI). Further, and based on more accurate registration, the embodiments allow for more accurate image reconstructions (e.g., PET, SPECT image reconstructions). For instance, the embodiments can reduce various types of attenuation correction artifacts in reconstructed PET images of subjects that move during scanning. Based on more accurate image reconstructions, the embodiments can allow medical providers to more easily and accurately diagnose patient scans. Moreover, the embodiments can allow a patient to be scanned at various times and even at various locations. For example, because of the temporal and/or image scanning system differences, the images captured from the patient may be misaligned. The embodiments, however, can allow for rigid alignment between these images. Persons of ordinary skill in the art may recognize these and other advantages as well.

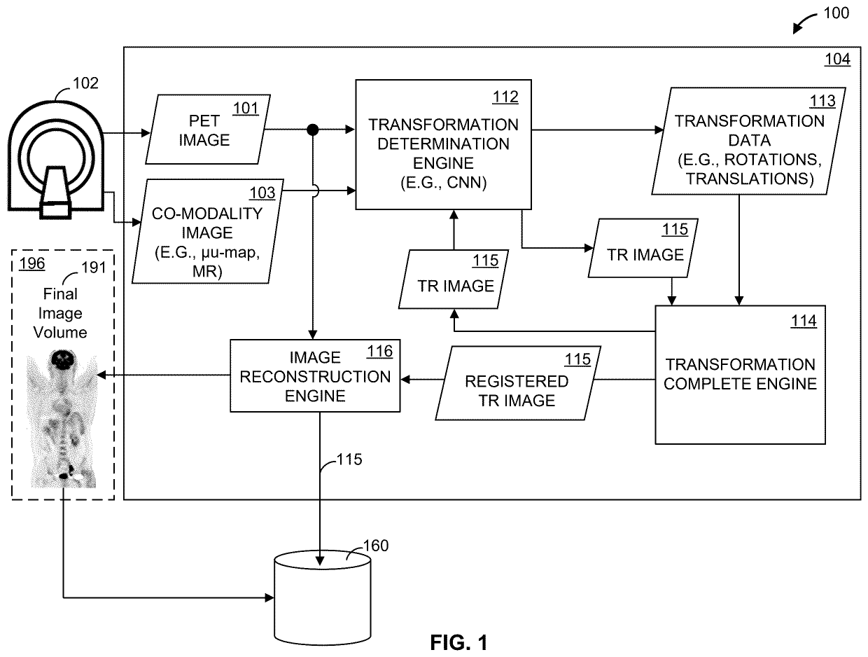

FIG. 1 illustrates an embodiment of a nuclear imaging system 100. As illustrated, nuclear imaging system 100 includes image scanning system 102 and image reconstruction system 104. Image scanning system 102 can be, for instance, a PET/CT scanner that can capture PET and CT images. In other examples, the image scanning system 102 can be a PET/MR system, for instance.

In this example, image scanning system 102 can scan a subject using a co-modality scanner, such as a CT or MR scanner, and can generate, based on the scans, co-modality images 103. The co-modality image 103 can be, for instance, an attenuation map such as a μu-map (e.g., based on CT scans), or an MR image (e.g., based on MR scans). Image scanning system 102 can also capture PET images 101 (e.g., based on PET raw data, such as sinogram data or list mode data) using a PET scanner. The PET image 101 can represent anything imaged in the scanner's field-of-view (FOV) containing positron emitting isotopes. For example, the PET image 101 can represent whole-body image scans, such as image scans from a patient's head to thigh. Image scanning system 102 can transmit the co-modality image 103 and the PET image 101 to image reconstruction system 104.

Image reconstruction system 104 includes transformation determination engine 112, transformation complete engine 114, and image reconstruction engine 116. In some examples, all or parts of transformation determination engine 112, transformation complete engine 114, and image reconstruction engine 116 are implemented in hardware, such as in one or more field-programmable gate arrays (FPGAs), one or more application-specific integrated circuits (ASICs), one or more state machines, one or more computing devices, digital circuitry, or any other suitable circuitry. In some examples, all or parts of transformation determination engine 112, transformation complete engine 114, and image reconstruction engine 116 can be implemented in software as executable instructions such that, when executed by one or more processors, cause the one or more processors to perform respective functions as described herein. The instructions can be stored in a non-transitory, computer-readable storage medium, for instance.

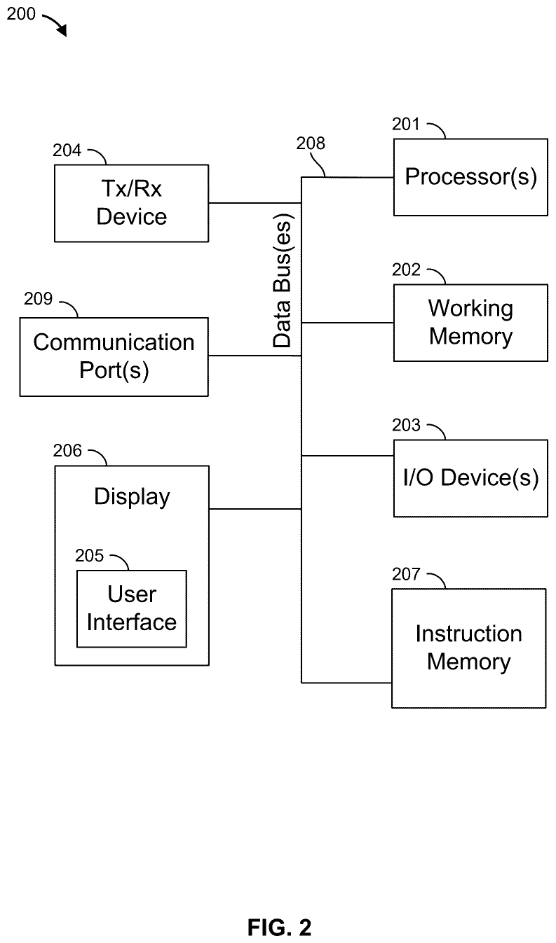

For example, FIG. 2 illustrates a computing device 200 that can be employed by the image reconstruction system 104. Computing device 200 can implement, for example, one or more of the functions of image reconstruction system 104 described herein.

Computing device 200 can include one or more processors 201, working memory 202, one or more input/output devices 203, instruction memory 207, a transceiver 204, one or more communication ports 209, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like. Processors 201 can be configured to perform a certain function or operation by executing code, stored on instruction memory 207, embodying the function or operation. For example, processors 201 can be configured to perform one or more of any function, method, or operation disclosed herein by executing instructions stored in instruction memory 207.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory. For example, instruction memory 207 can store instructions that, when executed by the one or more processors 201, cause one or more processors 201 to perform one or more of the functions of image reconstruction system 104, such as one or more of the functions of any of the transformation determination engine 112, transformation complete engine 114, and image reconstruction engine 116, as described herein.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of computing device 200. Working memory 202 can be a random access memory (RAM) such as a static random access memory (SRAM) or dynamic random access memory (DRAM), or any other suitable memory.

Input/output devices 203 can include any suitable device that allows for data input or output. For example, input/output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 209 allow for the transfer (e.g., uploading or downloading) of data, such as the PET images 101 and co-modality images 103 described further herein.

Display 206 can display user interface 205. User interfaces 205 can enable user interaction with computing device 200. For example, user interface 205 can be a user interface for an application that allows for the viewing of the final image volumes 191 described further herein. In some examples, a user can interact with user interface 205 by engaging (e.g., touching with a finger or stylus) an input/output device 203. In some examples, display 206 can be a touchscreen, where user interface 205 is displayed on the touchscreen.

Transceiver 204 allows for communication with a network, such as a Wi-Fi® network, an Ethernet network, a cellular network, or any other suitable communication network. For example, if operating in a Wi-Fi® network, transceiver 204 is configured to allow communications with the Wi-Fi® network (e.g., and, in some examples, other devices on the Internet to which the Wi-Fi® network is connected). Processor(s) 201 is operable to receive data from, or send data to, a network via transceiver 204.

Referring back to FIG. 1, transformation determination engine 112 receives the PET image 101 and co-modality image 103 from the image scanning system 102. Further, the transformation determination engine 112 applies a trained machine learning process to the PET image 101 and co-modality image 103 and, in response, generates transformation data 113 characterizing an alignment between the PET image 101 and co-modality image 103. In some instances, the trained machine learning model may be a trained neural network, such as a convolutional neural network. To generate the transformation data 113, the trained machine learning model can detect the alignment between the PET image 101 and the co-modality image 103 based on a comparison of pixel values of pixel locations in the PET image 101 and pixel values of pixel locations in the co-modality image 103, for instance.

The transformation data 113 can include a first value that indicates a linear offset of the co-modality image 103 from the PET image 101 in a first direction (e.g., the x direction, or the transaxial direction). The transformation data 113 can also include a second value that indicates a linear offset of the co-modality image 103 from the PET image 101 in a second direction (e.g., the y direction, or the sagittal direction). In addition, the transformation data 113 can include a third value that indicates a linear offset of the co-modality image 103 from the PET image 101 in a third direction (e.g., the z direction, or the coronal direction).

Additionally or alternatively, the transformation data 113 can include a fourth value that indicates a rotation offset of the co-modality image 103 from the PET image 101 around a first axis (e.g., the x axis, or axis in the transaxial direction). The transformation data 113 can also include a fifth value that indicates a rotation offset of the co-modality image 103 from the PET image 101 around a second axis (e.g., the y axis, or axis in the sagittal direction). In addition, the transformation data 113 can include a sixth value that indicates a rotation offset of the co-modality image 103 from the PET image 101 around a third axis (e.g., the z axis, or axis in the coronal direction).

The transformation determination engine 112 also adjusts the co-modality image 103 based on the transformation data 113 to generate a transformed image 115 (i.e., a transformed co-modality image). For instance, the transformation engine 112 can adjust pixel positions of the co-modality image 103 based on the offset values and/or rotation values of the transformation data 113, thereby translating and/or rotating the co-modality image 103 to generate the transformed image 115. As an example, if the transformation data 113 indicates an offset in the x direction by 50 pixels and in the y direction by-35 pixels, and a rotation in the z direction by 4 degrees, the transformation determination engine 112 writes the pixel value of each pixel position of the co-modality image 103 to a position in the transformed image 115 that is −50 pixels in the x direction, 35 pixels in the y direction, and rotated in the z direction by −4 degrees, thereby aligning the transformed image 115 with the PET image 101.

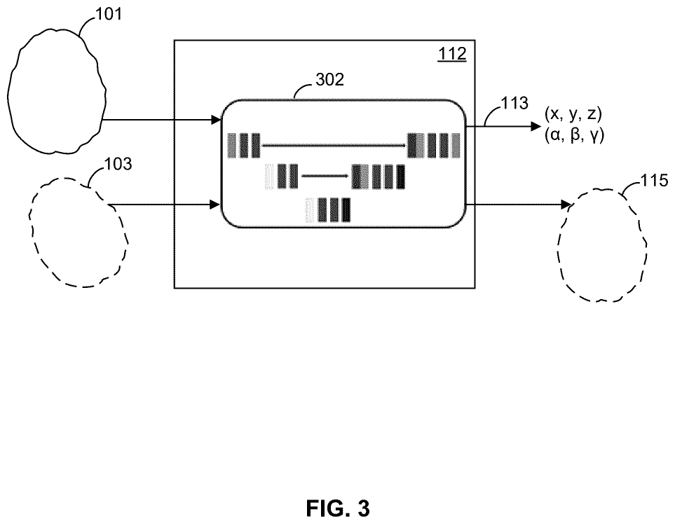

FIG. 3, for example, illustrates an example of the functionality of the transformation determination engine 112. In this example, a PET image 101 and a CT image 103 (e.g., an anatomical image) are inputted to a trained neural network 302. As illustrated, the CT image 103 is misaligned with (e.g., oriented differently than) the PET image 101. In some instances, the trained neural network 302 may be a trained CNN. The trained neural network 302 is configured to determine a misalignment between the PET image 101 and the CT image 103, and generate transformation data 113 characterizing the misalignment. For example, as illustrated, the transformation data 113 can include x, y, and z linear offsets, and α, β and γ rotation offsets. Further, the trained neural network 302 is configured to generate the transformed image 115 based on adjusting pixel positions of the CT image 103 to better align (e.g., align) with corresponding pixels of the PET image 101. As illustrated, the transformed image 115 is aligned with (e.g., oriented similarly to) the PET image 101.

Referring back to FIG. 1, the transformation complete engine 114 receives the transformation data 113 and transformed image 115 from the transformation determination engine 112, and determines whether the transformed image 115 is registered (e.g., sufficiently aligned) with the PET image 101 based on the transformation data 113. In some examples, the transformation complete engine 114 can compare one or more values (e.g., offset values, rotation values) of the transformation data 113 with corresponding thresholds to determine if the transformed image 115 is registered with the PET image 101. For instance, the transformation complete engine 114 may obtain (e.g., from an internal memory, from data repository 160, etc.) threshold data 117 that includes one or more transformation threshold values. The threshold data 117 can include a first linear offset threshold value, a second linear offset threshold value, and a third linear offset threshold value. The first linear offset threshold value, second linear offset threshold value, and third linear offset threshold value can correspond to a linear offset along a particular axis (e.g., x, y, z offsets in the x, y, z coordinate system, or offsets in the transaxial, sagittal, and coronal directions). The transformation complete engine 114 can compare each of the linear offsets of the transformation data 113 to the first linear offset threshold value, second linear offset threshold value, and third linear offset threshold value, respectively, and determine whether the transformed image 115 is registered with the PET image 101 based on the comparisons.

For example, the transformation complete engine 114 may determine that the transformed image 115 is registered with the PET image 101 when each of the linear offsets of the transformation data 113 are less than their corresponding first linear offset threshold value, second linear offset threshold value, and third linear offset threshold value. In some instances, the transformation complete engine 114 may determine that the transformed image 115 is registered with the PET image 101 when a minimum number (e.g., two) of the linear offsets of the transformation data 113 are less than their corresponding first linear offset threshold value, second linear offset threshold value, and third linear offset threshold value.

In other examples, the transformation complete engine 114 can apply an algorithm to the transformation data 113 to determine if the transformed image 115 is registered with the PET image 101. For instance, the algorithm may include determining an average value of the various offset values, an average value of the various rotation values, and determining whether the transformed image 115 is registered with the PET image 101 based on the average offset and rotation values.

Additionally or alternatively, the threshold data 117 can include a first rotation offset threshold value, a second rotation offset threshold value, and a third rotation offset threshold value. The first rotation offset threshold value, second rotation offset threshold value, and third rotation offset threshold value can correspond to a rotation offset for a particular axis (e.g., α, β, γ rotations around a corresponding axis)). The transformation complete engine 114 may determine that the transformed image 115 is registered with the PET image 101 when each of the rotation offsets of the transformation data 113 are less than their corresponding first rotation offset threshold value, second rotation offset threshold value, and third rotation offset threshold value (e.g., in addition or alternate to the linear offsets being less than their corresponding linear offset threshold values). In some instances, the transformation complete engine 114 may determine that the transformed image 115 is registered with the PET image 101 when a minimum number (e.g., two) of the rotation offsets of the transformation data 113 are less than their corresponding first rotation offset threshold value, second rotation offset threshold value, and third rotation offset threshold value.

As will be understood, other processes of determining when the transformed image 115 is registered with the PET image 101 based on the transformation data 113 are contemplated herein. For instance, the transformation complete engine 114 may determine that the transformed image 115 is registered with the PET image 101 based on any suitable algorithm that operates on at least portions of the transformation data 113.

If the transformation complete engine 114 determines that the transformed image 115 is not yet registered with the PET image 101 (e.g., linear offsets and/or rotation offsets above their corresponding thresholds), the transformation complete engine 114 transmits the transformed image 115 to the transformation determination engine 112. In response, the transformation determination engine 112 applies the trained machine learning process to the PET image 101 and the transformed image 115 (e.g., rather than the co-modality image 103) to generate additional transformation data 113 and an additional transformed image 115. For instance, while the transformation determination engine 112 applied the trained machine learning process to the PET image 101 and the co-modality image 103 in a first iteration (e.g., first “pass-through”) to generate first transformation data 113 and first transformed image 115, the transformation determination engine 112 now applies the trained machine learning process to the PET image 101 and the transformed image 115 in a second iteration (e.g., second “pass-through”) to generate second transformation data 113 and second transformed image 115.

Just as described above, the transformation complete engine 114 determines whether the additional transformed image 115 (e.g., second transformed image 115) is registered with the PET image 101 based on the additional transformation data 113 (e.g., the second transformation data 113). If the transformation complete engine 114 determines that the additional transformed image 115 is not yet registered with the PET image 101 (e.g., linear offsets and/or rotation offsets above their corresponding thresholds), the transformation complete engine 114 process described above repeats, where the transformation complete engine 114 transmits the additional transformed image 115 to the transformation determination engine 112 (e.g., for another iteration) to continue the alignment process until convergence completes.

Once the transformation complete engine 114 determines that the transformed image 115 (e.g., of the current iteration) is registered with the PET image 101 (e.g., linear offsets and/or rotation offsets at or below their corresponding thresholds), the transformation complete engine 114 transmits the registered transformed image 115 to the image reconstruction engine 116. In some examples, the transformation complete engine 114 determines that the transformed image 115 (e.g., of the current iteration) is registered with the PET image 101 after a predetermined maximum number of iterations (e.g., 4, 5, 6, etc.) where the transformed image 115 failed to register with the PET image 101. Once the transformation complete engine 114 determines that the maximum number of iterations have occurred, the transformation complete engine 114 transmits the registered transformed image 115 to the image reconstruction engine 116 for processing.

In this example, the image reconstruction engine 116 receives the registered transformed image 115 and the PET image 101, and generates a final image volume 191. For instance, the image reconstruction engine 116 may apply an image reconstruction process to the registered transformed image 115 and the PET image 101 to generate the final image volume 191. In some examples, the image reconstruction process includes inputting the registered transformed image 115 and the PET image 101 to a trained reconstruction neural network (e.g., trained CNN), where the trained reconstruction neural network generates the final image volume 191 based on the inputted registered transformed image 115 and the PET image 101. In some instances, the image reconstruction engine 116 applies an artificial intelligence process, such as a Fast PET process, to the registered transformed image 115 and the PET image 101 to generate the final image volume 191. The image reconstruction engine 116 may then store one or more of the registered transformed image 115 and the final image volume 191 in the data repository 160.

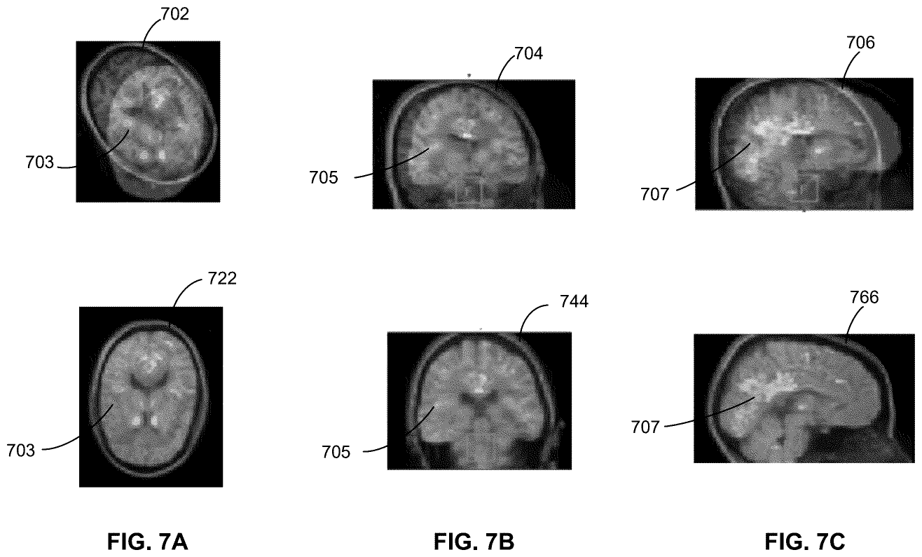

FIGS. 7A, 7B, and 7C illustrates example images that can be input to the trained machine learning models, as well as corresponding registrations output by the trained machine learning models, described herein. For example, FIG. 7A illustrates, from a transaxial viewpoint, a PET image 703 as well as an MR image 702. As described herein, the PET image 703 and the MR image 702 can be input to a trained machine learning model, such as neural network 302, to generate transformation data (e.g., transformation data 113) and a transformed image (e.g., transformed image 115). Based on the transformation data, the transformed image can be inputted back into the trained machine learning model, along with the PET image 703, to generate an additional transformed image and additional transformation data. This iterative process of inputting the generated transformed image for another pass through the trained machine learning model continues until registration is considered complete (e.g., transformation data values are below a threshold, a maximum number of iterations have taken place). As illustrated in FIG. 7A, the registered transformed MR image 722 is in greater alignment with the PET image 703 than is the original MR image 702.

Similarly, FIG. 7B illustrates, from a sagittal viewpoint, a PET image 705 and an MR image 704. Similarly to as described above, the PET image 705 and the MR image 704 can be input to the trained machine learning model to generate transformation data where, based on the transformation data, the transformed image can be inputted back into the trained machine learning model, along with the PET image 705, to generate an additional transformed image and additional transformation data. This iterative process of inputting the generated transformed image for another pass through the trained machine learning model continues until registration is considered complete. As illustrated in FIG. 7B, the registered transformed MR image 744 is in greater alignment with the PET image 705 than is the original MR image 704.

FIG. 7C illustrates, from a coronal viewpoint, a PET image 707 and an MR image 706. Similarly to as described above, the PET image 707 and the MR image 706 can be input to the trained machine learning model to generate transformation data where, based on the transformation data, the transformed image can be inputted back into the trained machine learning model, along with the PET image 707, to generate an additional transformed image and additional transformation data. This iterative process of inputting the generated transformed image for another pass through the trained machine learning model continues until registration is considered complete. As illustrated in FIG. 7C, the registered transformed MR image 766 is in greater alignment with the PET image 707 than is the original MR image 706.

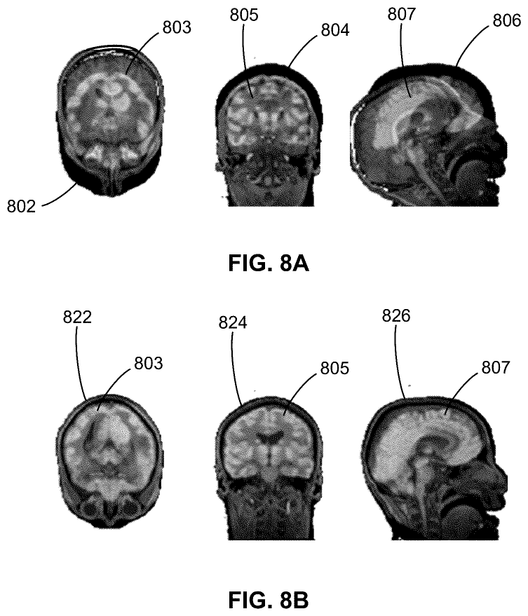

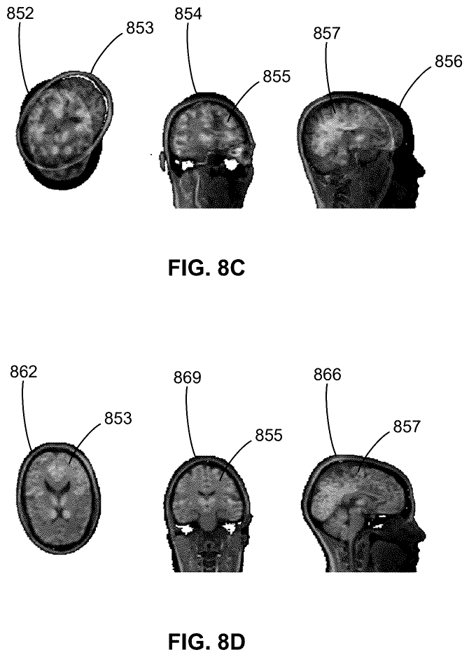

FIGS. 8A, 8B, 8C, and 8D illustrate further examples. For example, FIG. 8A illustrates a PET image 803 and a co-modality image 802 in the transaxial view, a PET image 805 and a co-modality image 804 in the sagittal view, and a PET image 807 and a co-modality image 806 in the coronal view. Each of the PET images 803, 805, 807 and co-modality images 802, 804, 806 can be received from, for example, the image scanning system 102. FIG. 8B illustrates, in the transaxial view, a registered transformed co-modality image 822 that is in greater alignment with the PET image 803 than is the original co-modality image 802. FIG. 8B also illustrates, in the sagittal view, a registered transformed co-modality image 824 that is in greater alignment with the PET image 805 than is the original co-modality image 804. Further, FIG. 8B illustrates, in the coronal view, a registered transformed co-modality image 826 that is in greater alignment with the PET image 807 than is the original co-modality image 806. Each of the registered transformed co-modality images 822, 824, 826 can be generated in accordance with at least one of the iterative machine learning processes described herein.

FIG. 8C illustrates a PET image 853 and a co-modality image 852 in the transaxial view, a PET image 855 and a co-modality image 854 in the sagittal view, and a PET image 857 and a co-modality image 856 in the coronal view. Each of the PET images 853, 855, 857 and co-modality images 852, 854, 856 can be received from, for example, the image scanning system 102. FIG. 8D illustrates, in the transaxial view, a registered transformed co-modality image 862 that is in greater alignment with the PET image 853 than is the original co-modality image 852. FIG. 8D also illustrates, in the sagittal view, a registered transformed co-modality image 864 that is in greater alignment with the PET image 855 than is the original co-modality image 854. Further, FIG. 8D illustrates, in the coronal view, a registered transformed co-modality image 866 that is in greater alignment with the PET image 857 than is the original co-modality image 856. Each of the registered transformed co-modality images 862, 864, 866 can be generated in accordance with at least one of the iterative machine learning processes described herein.

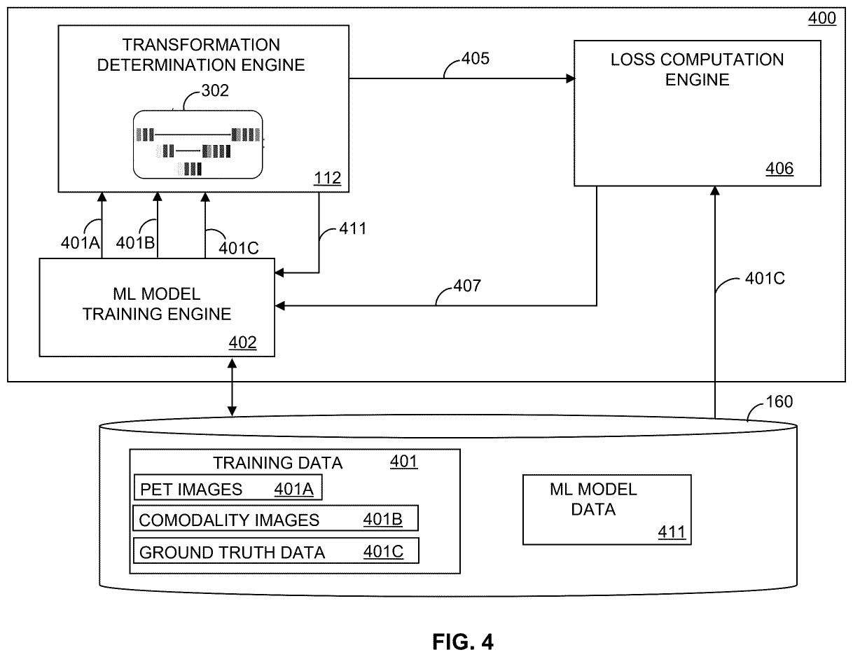

FIG. 4 illustrates a machine learning model training system 400 that includes a machine learning (ML) model training engine 402, the transformation engine 112, and a loss computation engine 406. In some examples, all or parts of the machine learning model training system 400 are implemented in hardware, such as in one or more FPGAs, one or more ASICs, one or more state machines, one or more computing devices, digital circuitry, or any other suitable circuitry. In some examples, parts or all of the machine learning model training system 400 can be implemented in software as executable instructions such that, when executed by one or more processors, cause the one or more processors to perform respective functions as described herein. For instance, in some examples, processors 201 of computing device 200 can execute instructions stored in instruction memory 207 to carry out one or more of the functions of any of the model training engine 402, the transformation engine 112, and the loss computation engine 406.

As illustrated, data repository 160 includes training data 401 that can be used to train a machine learning model to generate transformation data characterizing misalignments between images. The training data 401 includes PET images 401A and corresponding co-modality images 401B. Each pair of PET images 401A and co-modality images 401B can be based on scans of a patient. In addition, the training data 401 includes ground truth data 401C characterizing expected misalignments between the corresponding pairs of PET images 401A and co-modality images 401B. For instance, the ground truth data 401C may include a 3D displacement vector characterizing a displacement in each of an X, Y, and Z direction between corresponding pixels of each pair of PET images 401A and co-modality images 401B. The ground truth data 401C may, additionally or alternatively, include a 3D rotation vector characterizing a rotation around each of the X, Y, and Z axis between corresponding pixels of each pair of PET images 401A and co-modality images 401B.

In some instances, to generate misaligned pairs of PET images 401A and co-modality images 401B, the ML model training engine 402 may generate an adjusted PET image 401A by adjusting pixel locations of what is otherwise a PET image that is aligned to a co-modality image 401B (e.g., purposeful misalignment). Based on the adjustment, the ML model training engine 402 generates corresponding ground truth data 401C (i.e., the ground truth data 401C characterizes the misalignment) for the adjusted PET image 401A and the co-modality image 401B. Similarly, in some instances, the ML model training engine 402 may generate an adjusted co-modality image 401B by adjusting pixel locations of what is otherwise a co-modality image that is aligned to a PET image 401A. Based on the adjustment, the ML model training engine 402 generates corresponding ground truth data 401C for the adjusted co-modality image 401B and the PET image 401A.

To train the neural network 302, the ML model training engine 402 receives, from the data repository 160, one or more epochs of training data 401 that include corresponding pairs of PET images 401A and co-modality images 401B, as well as ground truth data 401C, and transmits the pairs of PET images 401A and co-modality images 401B and the ground truth data 401C to the transformation determination engine 112. Further, the transformation determination engine 112 inputs the pairs of PET images 401A and co-modality images 401B to the neural network 302. For instance, the transformation determination engine 112 may generate PET feature vectors based on the PET images 401A, and co-modality feature vectors based on the co-modality images 401B. The transformation determination engine 112 may input the PET feature vectors and the co-modality feature vectors to the neural network 302 and, based on the inputted PET feature vectors and co-modality feature vectors, the neural network 302 generates transformation data 405 characterizing misalignments between the inputted PET feature vectors and co-modality feature vectors.

The transformation determination engine 112 can adjust one or more weights of the neural network 302 during the training. For example, the transformation determination engine 112 can compute a loss based on the transformation data 405 and the ground truth data 401C, and can adjust the one or more weights based on the computed loss. The loss function can be, for example, a mean squared error (MSE) loss function, or any other suitable loss function. In some instances, the transformation determination engine 112 attempts to minimize an objective function that operates on the transformation data 405 and the ground truth data 401C. For example, the objective function can generate error data based on a comparison of the transformation data 405 with the corresponding ground truth data 401C. Based on the error data, the transformation determination engine 112 can update the weights of the neural network 302. For instance, the transformation determination engine 112 may adjust the weights of the neural network 302 according to a learning rate constraint of the objective function.

Further, the loss computation engine 406 may receive the transformation data 405 from the transformation determination engine 112, and the ground truth data 401C from the data repository 160. The loss computation engine 406 may determine a loss value 407 based on the transformation data 405 and the ground truth data 401C. For example, the loss computation engine 406 may compute the loss value 407 based on a loss function. The loss value 407 can be computed using any suitable loss function (e.g., image reconstruction loss function), such as any of the mean square error (MSE), mean absolute error (MAE), binary cross-entropy (BCE), Sobel, Laplacian, and Focal binary loss functions. The loss computation engine 406 can transmit the loss value 407 to the ML model training engine 402.

Based on the loss value 407, the ML model training engine 402 can determine whether the neural network 302 is trained. For instance, if the loss value 407 at least meets (e.g., exceeds, is below) a corresponding loss threshold, then the ML model training engine 402 determines that the neural network 302 is trained. The ML model training engine 402 may obtain ML model data 411 associated with the trained neural network 302 from the transformation determination engine 112, and may store the ML model data 411 within the data repository 160. The ML model data 411 can include parameters of the trained neural network 302, such as weights, hyperparameters, constraint values, and coefficients. The trained neural network 302 can be established (e.g., configured and executed) based on the ML model data 411.

Otherwise, if the loss value 407 does not at least meet the loss threshold, the ML model training engine 402 determines that the neural network 302 is not trained. In this case, the ML model training engine 402 continues to transmit PET images 401A and co-modality images 401B (e.g., epochs of PET images 401A and co-modality images 401B) to the transformation determination engine 112 to continue training the neural network 302. The training of the neural network 302 may continue until the loss value 407 at least meets the loss threshold.

In some instances, once the loss at least meets the loss threshold, the neural network 302 may be validated using previously unused PET images 401A and co-modality images 401B. For example, the ML model training engine 402 may transmit additional PET images 401A and co-modality images 401B to the transformation determination engine 112 for inputting to the neural network 302. In response, the neural network 302 can generate additional transformation data 405 characterizing misalignments between the additional PET images 401A and co-modality images 401B. The loss computation engine 406 can receive the additional transformation data 405, and can compute a loss value 407 based on the additional transformation data 405 and additional ground truth data 401C. The loss computation engine 406 can transmit the loss value 407 to the ML model training engine 402. The model training engine 402 can determine whether the neural network 302 is validated based on the loss value 407. For example, if the loss value 407 at least meets (e.g., exceeds, is below) a corresponding loss threshold, then the ML model training engine 402 determines that the neural network 302 is validated. The ML model training engine 402 may then obtain the ML model data 411 from the transformation determination engine 112, and may store the ML model data 411 within the data repository 160. Otherwise, if the loss value 407 does not at least meet the loss threshold, the ML model training engine 402 determines that the neural network 302 is not validated, and may continue to train and validate the neural network 302 as described herein.

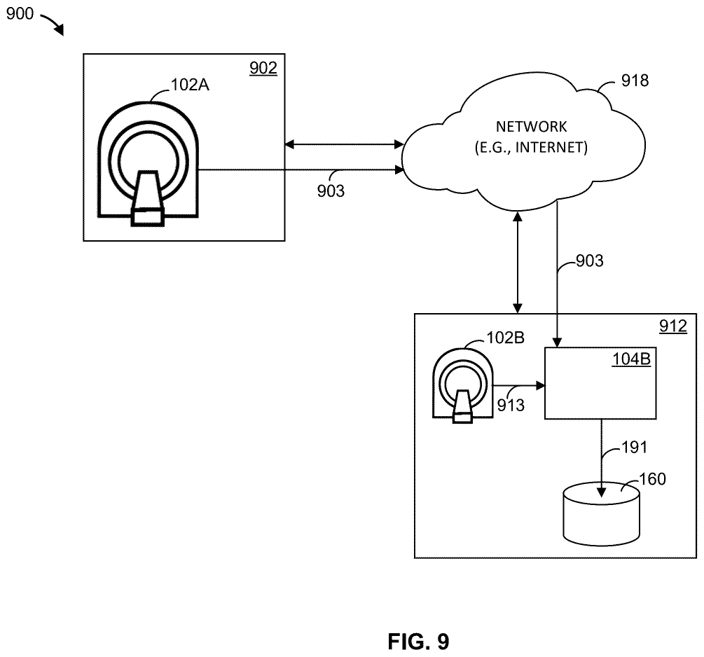

FIG. 9 illustrates a nuclear image reconstruction system 900 that includes a first medical facility 902 and a second medical facility 912. The first medical facility 902 includes an image scanning system 102A, such as a PET scanning system. The second medical facility 912 includes an image scanning system 102B, such as a PET/CT or PET/MR image scanning system. The image scanning system 102B is communicatively coupled to an image reconstruction system 104B, such as the image reconstruction system 104 of FIG. 1. Each of the first medical facility 902 and the second medical facility 912 are communicatively coupled to a network 918, such as the Internet.

In this example, a PET image 903 of a patient may be generated using the image scanning system 102A at the first medical facility 902. At a different time and/or day, a co-modality image 913 may be generated using a co-modality scanner, such as a CT scanner or MR scanner, of the image scanning system 102B at the second medical facility 912. The image reconstruction system 104B can receive not only the co-modality image 913 from the image scanning system 102B, but can also receive the PET image 903 from the image scanning system 102A over the network 918.

Further, the image reconstruction system 104B can register the co-modality image 913 with the PET image 903 based on any of the iterative machine learning processes described herein. For example, the image reconstruction system 104B can input the co-modality image 913 and the PET image 903 to the trained neural network 302 to generate transformation data 113 characterizing misalignments between the co-modality image 913 and the PET image 903 and a corresponding transformed image 115, which as described herein is the co-modality image 913 adjusted based on the transformation data 113.

Further, and based on the transformation data 113, the image reconstruction system 104B may input the generated transformed image 115 into the trained neural network 302, along with the PET image 903, to generate additional transformation data 113 characterizing misalignments between the initial transformed image 115 and the PET image 903, and a corresponding additional transformed image 115. The image reconstruction system 104B may continue to iteratively input the last generated transformed image 115 into the trained neural network 302 until the image reconstruction system 104B determines, based on the corresponding transformation data 113, that convergence has been reached.

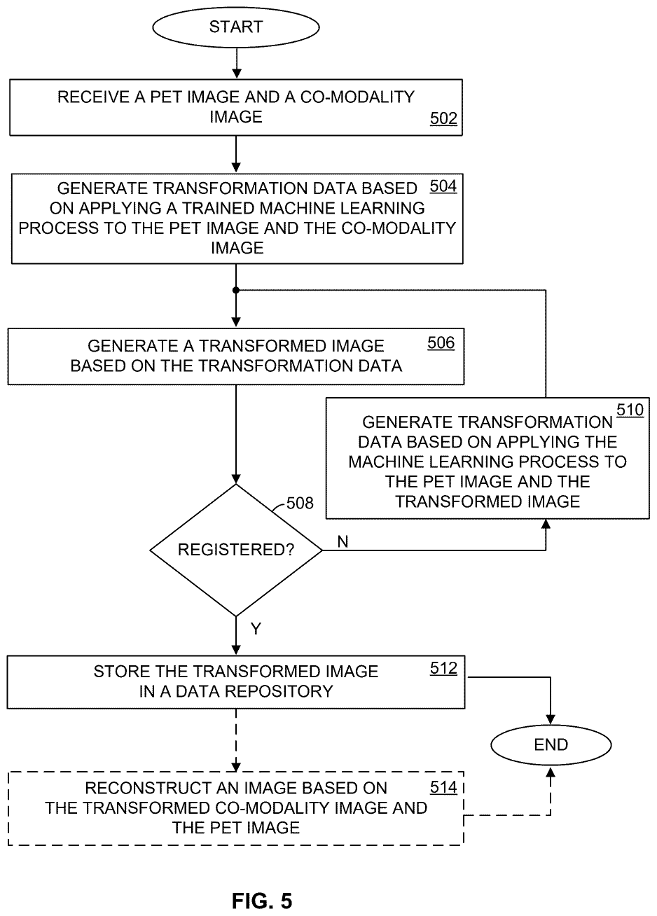

FIG. 5 is a flowchart of an example method 500 to generate a registered attenuation map. The method can be performed by, for example, the image reconstruction system 104.

Beginning at block 502, a PET image and a co-modality image are received. For instance, image reconstruction system 104 may receive a PET image 101 and co-modality image 103 (e.g., MR image) from the image scanning system 102. At block 504, a trained machine learning process is applied to the PET image and the co-modality image. Based on applying the trained machine learning process, transformation data is generated. The transformation data characterizes an alignment between the PET image and the co-modality image. For example, and as described herein, the image reconstruction system 104 can input the PET image 101 and co-modality image 103 to a trained neural network (e.g., trained neural network 302) and, in response, the trained neural network generates transformation data 113 characterizing an alignment (e.g., misalignment) between the PET image 101 and co-modality image 103. Further, and at block 506, a transformed image is generated based on the transformation data. For example, and as described herein, the image reconstruction system 104 can adjust the co-modality image based on offset and rotation values characterized by the transformation data 113 to generate a transformed image 115. For instance, the image reconstruction system 104 can adjust pixel positions of the co-modality image 103 based on the offset values and/or rotation values of the transformation data 113, thereby translating and/or rotating the co-modality image 103 to generate the transformed image 115

Proceeding to block 508, a determination is made as to whether the transformed image is registered with the PET image. For example, the image reconstruction system 104 can compare linear offset and rotation offset values of the transformation data 113 with corresponding threshold and, based on the comparisons, determine whether the transformed image 115 is sufficiently aligned with the PET image 101. For example, the image reconstruction system 104 may determine that the transformed image 115 is registered with the PET image 101 when each of the linear and rotation offset values of the transformation data 113 are less than their corresponding threshold values. In some examples, the image reconstruction system 104 determine that the transformed image 115 is registered with the PET image 101 when the processes at blocks 506, 508, and 510, as described herein, have been repeated a predetermined number of times (e.g., 4, 6, etc.).

If the transformed image is not yet registered with the PET image, the method proceeds to block 510, where the machine learning process is applied to the PET image and the transformed image, and in response, additional transformation data is generated. For example, and as described herein, the image reconstruction system 104 can input the PET image 101 and transformed image 115 to the trained neural network (e.g., trained neural network 302) and, in response, the trained neural network generates additional transformation data 113 characterizing an alignment (e.g., misalignment) between the PET image 101 and the transformed image 115. The method then proceeds back to block 506, where an additional transformed image is generated based on the additional transformation data. The processes at blocks 506, 508, and 510 can repeat until, at block 508, the transformed image is determined to be registered with the PET image.

If at block 508, however, the transformed image is determined to be registered with the PET image, the method proceeds to block 512 where the registered transformed image (i.e., the last generated transformed image) is stored in a data repository, such as data repository 160.

In some examples, the method may proceed from block 512 to block 514, where an image is reconstructed based on the transformed image and the PET image. For example, and as described herein, the image reconstruction system 104 can generate the final image volume 191 based on applying an image reconstruction process to the registered transformed image 115 and the PET image 101.

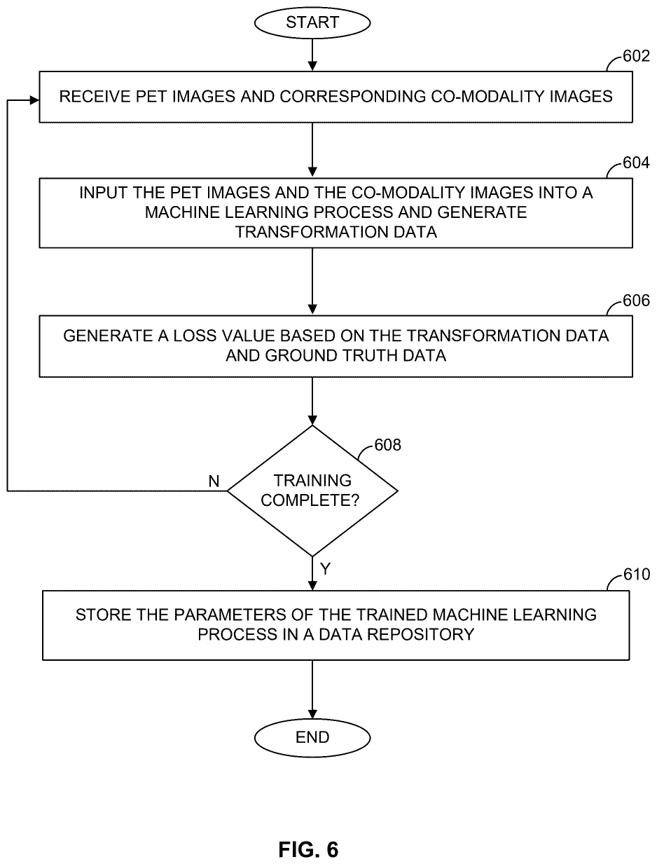

FIG. 6 is a flowchart of an example method 600 to train a machine learning model, such as the neural network 302. The method can be performed by, for example, the machine learning model training system 400.

Beginning at block 602, PET images and corresponding co-modality images are received. For example, the machine learning model training system 400 may obtain, from data repository 160, PET images 401A and co-modality images 401B. At block 604, the PET images and co-modality images are input to a machine learning process and, based on inputting the PET images and co-modality images, transformation data is generated. As described herein, the transformation data characterizes alignments (e.g., misalignments) between the inputted images. For instance, as described herein, the machine learning model training system 400 may input a PET image 401A and co-modality image 401B into the neural network 302 and, based on inputting the PET image 401A and the co-modality image 401B, generate transformation data 405 that characterizes linear and rotational offsets between the PET image 401A and co-modality image 401B. As described herein, parameters of the machine learning process can be adjusted during the training. For instance, the machine learning model training system 400 may train the machine learning model to minimize an objective function.

Further, at block 606, a loss value is generated based on the transformation data and ground truth data, where the ground truth data characterizes a misalignment between pairs of the PET images and co-modality images. The machine learning model training system 400 may generate the loss value 407 based on comparing the transformation data 405 with the ground truth data 401C. For example, the machine learning model training system 400 may compute the loss value 407 based on applying a loss function to the transformation data 405 and the ground truth data 401C.

Proceeding to block 608, a determination is made as to whether the machine learning process is trained. For example, the machine learning model training system 400 can compare the loss value 407 to a threshold value and, based on the comparison, determine whether the machine learning process is trained based on the comparison. The machine learning model training system 400 may determine, for instance, that the neural network 302 is trained when the loss value 407 is below a corresponding threshold value. The machine learning model training system 400 may determine, however, that the neural network 302 is not trained when the loss value 407 meets or exceeds the corresponding threshold value. If the machine learning process is not trained, the method proceeds back to block 602 to continue with training the machine learning process. Otherwise, if the machine learning process is trained, the method proceeds to block 612.

At block 612, parameters associated with the machine learning process is stored in a data repository. The parameters characterize the trained machine learning model. For example, the parameters can include, for instance, weights, hyperparameters, constraint values, and coefficients. For instance, as described herein, the machine learning model training system 400 may obtain ML model data 411 associated with the trained neural network 302, and may store the ML model data 411 within the data repository 160. The trained neural network 302 can be established (e.g., configured and executed) based on the stored parameters.

The following is a list of non-limiting illustrative embodiments disclosed herein:

Illustrative Embodiment 1: A computer-implemented method comprising:
receiving a positron emission tomography (PET) image and a co-modality image;
applying a trained machine learning process to the PET image and the co-modality image and, based on the application of the trained machine learning process to the PET image and the co-modality image, generating first transformation data characterizing an alignment between the PET image and the co-modality image;
generating a first transformed image based on the co-modality image and the first transformation data;
determining that the first transformed image is not registered with the PET image based on the first transformation data;
applying the trained machine learning process to the PET image and the first transformed image and, based on the application of the trained machine learning process to the PET image and the first transformed image, generating second transformation data characterizing an alignment between the PET image and the first transformed image;
generating a second transformed image based on the first transformed image and the second transformation data; and
storing the second transformed image in a data repository.

Illustrative Embodiment 2: The computer-implemented method of illustrative embodiment 1, further comprising determining that the second transformed image is registered with the PET image based on the second transformation data.

Illustrative Embodiment 3: The computer-implemented method of any of illustrative embodiments 1-2, further comprising comparing the second transformation data to threshold registration data, and determining that the second transformed image is registered with the PET image based on the comparisons.

Illustrative Embodiment 4: The computer-implemented method of any of illustrative embodiments 1-3, wherein the first transformation data comprises at least one linear offset value characterizing a linear offset between the PET image and the co-modality image, and at least one rotational offset value characterizing a rotation offset between the PET image and the co-modality image.

Illustrative Embodiment 5: The computer-implemented method of any of illustrative embodiments 1-4, wherein generating the first transformed image comprises adjusting pixel positions of the co-modality image based on the first transformation data.

Illustrative Embodiment 6: The computer-implemented method of any of illustrative embodiments 1-5, wherein applying the trained machine learning process to the PET image and the co-modality image comprises inputting the PET image and the co-modality image to a trained neural network.

Illustrative Embodiment 7: The computer-implemented method of illustrative embodiment 6, further comprising:
generating first feature vectors based on the PET image;
generating second feature vectors based on the co-modality image; and
inputting the first feature vectors and the second feature vectors into the trained neural network.

Illustrative Embodiment 8: The computer-implemented method of any of illustrative embodiments 1-7, further comprising reconstructing a final image based on the PET image and the second transformed image.

Illustrative Embodiment 9: The computer-implemented method of illustrative embodiment 8, further comprising providing the final image for display.

Illustrative Embodiment 10: The computer-implemented method of any of illustrative embodiments 1-9 comprising detecting, based on the application of the trained machine learning process to the PET image and the first transformed image, the alignment between the PET image and the co-modality image based on a comparison of pixel values of pixel locations in the PET image and pixel values of pixel locations in the co-modality image.

Illustrative Embodiment 11: The computer-implemented method of any of illustrative embodiments 1-10, wherein the PET image comprises one of time-of-flight (TOF) sinogram data and list mode data, and the co-modality image comprises one of a computed tomography (CT) image and a Magnetic Resonance (MR) image.

Illustrative Embodiment 12: The computer-implemented method of any of illustrative embodiments 1-11, wherein the trained machine learning process is trained on a plurality of PET images and corresponding co-modality images, and ground truth data characterizing misalignments between the plurality of PET images and the corresponding co-modality images.

Illustrative Embodiment 13: A non-transitory, computer readable medium storing instructions that, when executed by at least one processor, cause the at least one processor to perform operations comprising:
receiving a positron emission tomography (PET) image and a co-modality image;
applying a trained machine learning process to the PET image and the co-modality image and, based on the application of the trained machine learning process to the PET image and the co-modality image, generating first transformation data characterizing an alignment between the PET image and the co-modality image;
generating a first transformed image based on the co-modality image and the first transformation data;
determining that the first transformed image is not registered with the PET image based on the first transformation data;
applying the trained machine learning process to the PET image and the first transformed image and, based on the application of the trained machine learning process to the PET image and the first transformed image, generating second transformation data characterizing an alignment between the PET image and the first transformed image;
generating a second transformed image based on the first transformed image and the second transformation data; and
storing the second transformed image in a data repository.

Illustrative Embodiment 14: The non-transitory, computer readable medium of illustrative embodiment 13 storing instructions that, when executed by the at least one processor, further cause the at least one processor to perform operations comprising determining that the second transformed image is registered with the PET image based on the second transformation data.

Illustrative Embodiment 15: The non-transitory, computer readable medium of any of illustrative embodiments 13-14 storing instructions that, when executed by the at least one processor, further cause the at least one processor to perform operations comprising comparing the second transformation data to threshold registration data, and determining that the second transformed image is registered with the PET image based on the comparisons.

Illustrative Embodiment 16: The non-transitory, computer readable medium of any of illustrative embodiments 13-15, wherein the first transformation data comprises at least one linear offset value characterizing a linear offset between the PET image and the co-modality image, and at least one rotational offset value characterizing a rotation offset between the PET image and the co-modality image.

Illustrative Embodiment 17: The non-transitory, computer readable medium of any of illustrative embodiments 13-16, wherein generating the first transformed image comprises adjusting pixel positions of the co-modality image based on the first transformation data.

Illustrative Embodiment 18: The non-transitory, computer readable medium of any of illustrative embodiments 13-17, wherein applying the trained machine learning process to the PET image and the co-modality image comprises inputting the PET image and the co-modality image to a trained neural network.

Illustrative Embodiment 19: The non-transitory, computer readable medium of illustrative embodiment 18 storing instructions that, when executed by the at least one processor, further cause the at least one processor to perform operations comprising:
generating first feature vectors based on the PET image;
generating second feature vectors based on the co-modality image; and
inputting the first feature vectors and the second feature vectors into the trained neural network.

Illustrative Embodiment 20: The non-transitory, computer readable medium of any of illustrative embodiments 13-19 storing instructions that, when executed by the at least one processor, further cause the at least one processor to perform operations comprising reconstructing a final image based on the PET image and the second transformed image.

Illustrative Embodiment 21: The non-transitory, computer readable medium of illustrative embodiment 20 storing instructions that, when executed by the at least one processor, further cause the at least one processor to perform operations comprising providing the final image for display.

Illustrative Embodiment 22: The non-transitory, computer readable medium of any of illustrative embodiments 13-21 storing instructions that, when executed by the at least one processor, further cause the at least one processor to perform operations comprising detecting, based on the application of the trained machine learning process to the PET image and the first transformed image, the alignment between the PET image and the co-modality image based on a comparison of pixel values of pixel locations in the PET image and pixel values of pixel locations in the co-modality image.

Illustrative Embodiment 23: The non-transitory, computer readable medium of any of illustrative embodiments 13-22, wherein the PET image comprises one of time-of-flight (TOF) sinogram data and list mode data, and the co-modality image comprises one of a computed tomography (CT) image and a Magnetic Resonance (MR) image.

Illustrative Embodiment 24: The non-transitory, computer readable medium of any of illustrative embodiments 13-23, wherein the trained machine learning process is trained on a plurality of PET images and corresponding co-modality images, and ground truth data characterizing misalignments between the plurality of PET images and the corresponding co-modality images.

Illustrative Embodiment 25: A system comprising:
a memory storing instructions; and
at least one processor communicatively coupled to the memory and configured to execute the instructions to:
receive a positron emission tomography (PET) image and a co-modality image;
apply a trained machine learning process to the PET image and the co-modality image and, based on the application of the trained machine learning process to the PET image and the co-modality image, generate first transformation data characterizing an alignment between the PET image and the co-modality image;
generate a first transformed image based on the co-modality image and the first transformation data;
determine that the first transformed image is not registered with the PET image based on the first transformation data;
apply the trained machine learning process to the PET image and the first transformed image and, based on the application of the trained machine learning process to the PET image and the first transformed image, generate second transformation data characterizing an alignment between the PET image and the first transformed image;
generate a second transformed image based on the first transformed image and the second transformation data; and
store the second transformed image in a data repository.

Illustrative Embodiment 26: The system of illustrative embodiment 25, wherein the at least one processor is configured to execute the instructions to determine that the second transformed image is registered with the PET image based on the second transformation data.

Illustrative Embodiment 27: The system of any of illustrative embodiments 25-26, wherein the at least one processor is configured to execute the instructions to compare the second transformation data to threshold registration data, and determine that the second transformed image is registered with the PET image based on the comparisons.

Illustrative Embodiment 28: The system of any of illustrative embodiments 25-27, wherein the first transformation data comprises at least one linear offset value characterizing a linear offset between the PET image and the co-modality image, and at least one rotational offset value characterizing a rotation offset between the PET image and the co-modality image.

Illustrative Embodiment 29: The system of any of illustrative embodiments 25-28, wherein to generate the first transformed image, the at least one processor is configured to execute the instructions to adjust pixel positions of the co-modality image based on the first transformation data.

Illustrative Embodiment 30: The system of any of illustrative embodiments 25-29, wherein to apply the trained machine learning process to the PET image and the co-modality image, the at least one processor is configured to execute the instructions to input the PET image and the co-modality image to a trained neural network.

Illustrative Embodiment 31: The system of illustrative embodiment 30, wherein the at least one processor is configured to execute the instructions to:
generate first feature vectors based on the PET image;
generate second feature vectors based on the co-modality image; and
input the first feature vectors and the second feature vectors into the trained neural network.

Illustrative Embodiment 32: The system of any of illustrative embodiments 25-31, wherein the at least one processor is configured to execute the instructions to reconstruct a final image based on the PET image and the second transformed image.

Illustrative Embodiment 33: The system of illustrative embodiment 32, wherein the at least one processor is configured to execute the instructions to provide the final image for display.

Illustrative Embodiment 34: The system of any of illustrative embodiments 25-33, wherein the at least one processor is configured to execute the instructions to detect, based on the application of the trained machine learning process to the PET image and the first transformed image, the alignment between the PET image and the co-modality image based on a comparison of pixel values of pixel locations in the PET image and pixel values of pixel locations in the co-modality image.

Illustrative Embodiment 35: The system of any of illustrative embodiments 25-34, wherein the PET image comprises one of time-of-flight (TOF) sinogram data and list mode data, and the co-modality image comprises one of a computed tomography (CT) image and a Magnetic Resonance (MR) image.

Illustrative Embodiment 36: The system of any of illustrative embodiments 25-35, wherein the trained machine learning process is trained on a plurality of PET images and corresponding co-modality images, and ground truth data characterizing misalignments between the plurality of PET images and the corresponding co-modality images.

Illustrative Embodiment 37: A system comprising:
a means for receiving a positron emission tomography (PET) image and a co-modality image;
a means for applying a trained machine learning process to the PET image and the co-modality image and, based on the application of the trained machine learning process to the PET image and the co-modality image, generating first transformation data characterizing an alignment between the PET image and the co-modality image;
a means for generating a first transformed image based on the co-modality image and the first transformation data;
a means for determining that the first transformed image is not registered with the PET image based on the first transformation data;
a means for applying the trained machine learning process to the PET image and the first transformed image and, based on the application of the trained machine learning process to the PET image and the first transformed image, generating second transformation data characterizing an alignment between the PET image and the first transformed image;
a means for generating a second transformed image based on the first transformed image and the second transformation data; and
a means for storing the second transformed image in a data repository.

Illustrative Embodiment 38: The system of illustrative embodiment 37, comprising a means for determining that the second transformed image is registered with the PET image based on the second transformation data.

Illustrative Embodiment 39: The system of any of illustrative embodiments 37-38, comprising a means for comparing the second transformation data to threshold registration data, and determining that the second transformed image is registered with the PET image based on the comparisons.

Illustrative Embodiment 40: The system of any of illustrative embodiments 37-39, wherein the first transformation data comprises at least one linear offset value characterizing a linear offset between the PET image and the co-modality image, and at least one rotational offset value characterizing a rotation offset between the PET image and the co-modality image.

Illustrative Embodiment 41: The system of any of illustrative embodiments 37-40, wherein the means for generating the first transformed image comprises adjusting pixel positions of the co-modality image based on the first transformation data.

Illustrative Embodiment 42: The system of any of illustrative embodiments 37-41, wherein the means for applying the trained machine learning process to the PET image and the co-modality image comprises inputting the PET image and the co-modality image to a trained neural network.

Illustrative Embodiment 43: The system of illustrative embodiment 42, further comprising:
a means for generating first feature vectors based on the PET image;
a means for generating second feature vectors based on the co-modality image; and
a means for inputting the first feature vectors and the second feature vectors into the trained neural network.

Illustrative Embodiment 44: The system of any of illustrative embodiments 37-43, comprising a means for reconstructing a final image based on the PET image and the second transformed image.

Illustrative Embodiment 45: The system of illustrative embodiment 44, further comprising a means for providing the final image for display.

Illustrative Embodiment 46: The system of any of illustrative embodiments 37-45, wherein the means for applying the trained machine learning process to the PET image and the first transformed image comprises detecting the alignment between the PET image and the co-modality image based on a comparison of pixel values of pixel locations in the PET image and pixel values of pixel locations in the co-modality image.

Illustrative Embodiment 47: The system of any of illustrative embodiments 37-46, wherein the PET image comprises one of time-of-flight (TOF) sinogram data and list mode data, and the co-modality image comprises one of a computed tomography (CT) image and a Magnetic Resonance (MR) image.

Illustrative Embodiment 48: The system of any of illustrative embodiments 37-47, wherein the trained machine learning process is trained on a plurality of PET images and corresponding co-modality images, and ground truth data characterizing misalignments between the plurality of PET images and the corresponding co-modality images.

The apparatuses and processes are not limited to the specific embodiments described herein. In addition, components of each apparatus and each process can be practiced independent and separate from other components and processes described herein.

The previous description of embodiments is provided to enable any person skilled in the art to practice the disclosure. The various modifications to these embodiments will be readily apparent to those skilled in the art, and the generic principles defined herein can be applied to other embodiments without the use of inventive faculty. The present disclosure is not intended to be limited to the embodiments shown herein, but is to be accorded the widest scope consistent with the principles and novel features disclosed herein.

What is claimed is:

1. A computer-implemented method comprising:
receiving a positron emission tomography (PET) image and a co-modality image;
applying a trained machine learning process to the PET image and the co-modality image and, based on the application of the trained machine learning process to the PET image and the co-modality image, generating first transformation data characterizing an alignment between the PET image and the co-modality image;
generating a first transformed image based on the co-modality image and the first transformation data;
determining that the first transformed image is not registered with the PET image based on the first transformation data;
applying the trained machine learning process to the PET image and the first transformed image and, based on the application of the trained machine learning process to the PET image and the first transformed image, generating second transformation data characterizing an alignment between the PET image and the first transformed image;
generating a second transformed image based on the first transformed image and the second transformation data; and
storing the second transformed image in a data repository.

2. The computer-implemented method of claim 1, further comprising determining that the second transformed image is registered with the PET image based on the second transformation data.

3. The computer-implemented method of claim 1, further comprising comparing the second transformation data to threshold registration data, and determining that the second transformed image is registered with the PET image based on the comparisons.

4. The computer-implemented method of claim 1, wherein the first transformation data comprises at least one linear offset value characterizing a linear offset between the PET image and the co-modality image, and at least one rotational offset value characterizing a rotation offset between the PET image and the co-modality image.

5. The computer-implemented method of claim 1, wherein generating the first transformed image comprises adjusting pixel positions of the co-modality image based on the first transformation data.

6. The computer-implemented method of claim 1, wherein applying the trained machine learning process to the PET image and the co-modality image comprises inputting the PET image and the co-modality image to a trained neural network.

7. The computer-implemented method of claim 6, further comprising:
generating first feature vectors based on the PET image;
generating second feature vectors based on the co-modality image; and
inputting the first feature vectors and the second feature vectors into the trained neural network.

8. The computer-implemented method of claim 1, further comprising reconstructing a final image based on the PET image and the second transformed image.

9. The computer-implemented method of claim 8, further comprising providing the final image for display.

10. The computer-implemented method of claim 1 comprising detecting, based on the application of the trained machine learning process to the PET image and the first transformed image, the alignment between the PET image and the co-modality image based on a comparison of pixel values of pixel locations in the PET image and pixel values of pixel locations in the co-modality image.

11. The computer-implemented method of claim 1, wherein the PET image comprises one of time-of-flight (TOF) sinogram data and list mode data, and the co-modality image comprises one of a computed tomography (CT) image and a Magnetic Resonance (MR) image.

12. The computer-implemented method of claim 1, wherein the trained machine learning process is trained on a plurality of PET images and corresponding co-modality images, and ground truth data characterizing misalignments between the plurality of PET images and the corresponding co-modality images.

13. A non-transitory, computer readable medium storing instructions that, when executed by at least one processor, cause the at least one processor to perform operations comprising:
receiving a positron emission tomography (PET) image and a co-modality image;
applying a trained machine learning process to the PET image and the co-modality image and, based on the application of the trained machine learning process to the PET image and the co-modality image, generating first transformation data characterizing an alignment between the PET image and the co-modality image;
generating a first transformed image based on the co-modality image and the first transformation data;
determining that the first transformed image is not registered with the PET image based on the first transformation data;
applying the trained machine learning process to the PET image and the first transformed image and, based on the application of the trained machine learning process to the PET image and the first transformed image, generating second transformation data characterizing an alignment between the PET image and the first transformed image;
generating a second transformed image based on the first transformed image and the second transformation data; and
storing the second transformed image in a data repository.

14. The non-transitory, computer readable medium of claim 13 storing instructions that, when executed by the at least one processor, further cause the at least one processor to perform operations comprising determining that the second transformed image is registered with the PET image based on the second transformation data.

15. The non-transitory, computer readable medium of claim 13 storing instructions that, when executed by the at least one processor, further cause the at least one processor to perform operations comprising comparing the second transformation data to threshold registration data, and determining that the second transformed image is registered with the PET image based on the comparisons.

16. The non-transitory, computer readable medium of claim 13, wherein the first transformation data comprises at least one linear offset value characterizing a linear offset between the PET image and the co-modality image, and at least one rotational offset value characterizing a rotation offset between the PET image and the co-modality image.

17. A system comprising:
a memory storing instructions; and
at least one processor communicatively coupled to the memory and configured to execute the instructions to:
receive a positron emission tomography (PET) image and a co-modality image;
apply a trained machine learning process to the PET image and the co-modality image and, based on the application of the trained machine learning process to the PET image and the co-modality image, generate first transformation data characterizing an alignment between the PET image and the co-modality image;
generate a first transformed image based on the co-modality image and the first transformation data;
determine that the first transformed image is not registered with the PET image based on the first transformation data;
apply the trained machine learning process to the PET image and the first transformed image and, based on the application of the trained machine learning process to the PET image and the first transformed image, generate second transformation data characterizing an alignment between the PET image and the first transformed image;
generate a second transformed image based on the first transformed image and the second transformation data; and
store the second transformed image in a data repository.

18. The system of claim 17, wherein the at least one processor is configured to execute the instructions to determine that the second transformed image is registered with the PET image based on the second transformation data.

19. The system of claim 17, wherein the at least one processor is configured to execute the instructions to compare the second transformation data to threshold registration data, and determine that the second transformed image is registered with the PET image based on the comparisons.

20. The system of claim 17, wherein the first transformation data comprises at least one linear offset value characterizing a linear offset between the PET image and the co-modality image, and at least one rotational offset value characterizing a rotation offset between the PET image and the co-modality image.
